(19) United States
(12) Patent Application Publication
(10) Pub. No.: US 2012/0269592 A1
(43) Pub. Date: Oct. 25, 2012

(54) SYSTEM AND METHOD FOR MODIFYING A ROTOR

(76) Inventors: JAMES BRADFORD HOLMES, Fountain Inn, SC (US); John William Herbold, Fountain Inn, SC (US); Jason Matthew Clark, Loveland, OH (US)

(21) Appl. No.: 13/089,987

(22) Filed: Apr. 19, 2011

(51) Int. Cl. B23B 45/14; B23B 49/00; B23B 41/00

(52) U.S. Cl. 408/103; 408/131; 29/401.1

(57) ABSTRACT

A system for modifying a slot in a rotor includes a base having a vertical axis. A drill is slidingly connected to the base along the vertical axis, and a clamp is connected to the base and configured to engage with an interior surface of the slot. A method for modifying a slot in a rotor includes locating a drill proximate to the slot and inserting a clamp into the slot, wherein the clamp is slidingly connected to the drill. The method further includes engaging the clamp with an interior surface of the slot and operating the drill to create a cavity in the slot.

### FIELD OF THE INVENTION

The present invention generally involves a system and method for modifying a rotor. In particular, embodiments of the present invention provide a system and method for creating a cavity in a slot in the rotor.

### BACKGROUND OF THE INVENTION

Various forms of commercial equipment include rotating components. For example, a typical gas turbine includes an axial compressor at the front, one or more combustors around the middle, and a turbine at the rear. The compressor generally includes a casing that surrounds and encloses alternating stages of circumferentially mounted stator vanes and rotating blades. The stator vanes typically attach to the casing, and the rotating blades typically attach to a rotor inside the compressor. Ambient air enters the compressor, and each stage of stator vanes directs the airflow onto the following stage of rotating blades to progressively impart kinetic energy to the working fluid (air) to bring it to a highly energized state. The working fluid exits the compressor and flows to the combustors where it mixes with fuel and ignites to generate combustion gases having a high temperature and pressure. The combustion gases exit the combustors and flow to the turbine where they expand to produce work. For example, expansion of the combustion gases in the turbine may rotate a shaft connected to a generator to produce electricity.

The rotating blades in the compressor typically connect to the rotor in a manner that allows the rotating blades to be periodically removed for maintenance, inspections, and/or replacement. For example, the rotating blades may include a root or base that slides into a complementary dovetail slot in the rotor. The complementary surfaces between the root and the dovetail slot prevent each blade from moving radially, and the area on the rotor surrounding the slot may be “staked” or plastically deformed to prevent the root from moving axially in the slot. In this manner, each rotating blade may be removed from the rotor, and the same or a replacement blade may be re-inserted into the dovetail slot before the rotor is re-staked to hold the blade in place.

The area on the surface of the rotor suitable for staking the blade is finite and will therefore permit removal and re-staking of the blade a limited number of times. As a result, various systems and methods have been developed to modify the rotor to permit the blades to be removed and re-staked multiple times. For example, U.S. Patent Publication 2009/0077795, assigned to the same assignee as the present application, describes a system and method in which a drill is used to create a recess in the bottom of the slot. An insert may then be placed in the recess and staked to hold the blade axially in place. In the event that the blade must be removed from the rotor again, a new insert may be used to again stake the blade axially in place.

The modification to the slot in the rotor typically requires substantial disassembly of the compressor and associated equipment to provide suitable access to the rotor. For example, the casing surrounding the rotating blades is often completely removed, and scaffolding is erected around the rotor to support the equipment and personnel performing the modification. In addition, the gas turbine itself may be situated in a building having walls and/or a roof that must be removed or otherwise opened to provide sufficient access to the rotor. This disassembly and staging is expensive to perform, extends the time needed for the rotor modification, and increases the outage associated with the modification. Therefore, an improved system and method for modifying the slot in the rotor that reduces the amount of disassembly of the compressor and staging would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for modifying a slot in a rotor. The system includes a base having a vertical axis. A drill is slidingly connected to the base along the vertical axis, and a clamp is connected to the base and configured to engage with an interior surface of the slot.

Another embodiment of the present invention is a system for modifying a slot in a rotor. The system includes a base having a vertical axis. The system further includes a drill slidingly connected to the base along the vertical axis and means for aligning the drill above the slot.

The present invention may also include a method for modifying a slot in a rotor. The method includes locating a drill proximate to the slot and inserting a clamp into the slot, wherein the clamp is slidingly connected to the drill. The method further includes engaging the clamp with an interior surface of the slot and operating the drill to create a cavity in the slot.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross sectional view of an exemplary compressor;

FIG. 2 is an enlarged perspective view of a portion of a first stage of rotating blades in the compressor shown in FIG. 1;

FIG. 3 is an enlarged perspective view of the first stage of rotating blades shown in FIG. 2 after being modified with an embodiment of the present invention;

FIG. 4 is a perspective view of a system for modifying a rotor according to an embodiment of the present invention;

FIG. 5 is a top plan view of the system shown in FIG. 4;

FIG. 6 front plan view of the system shown in FIG. 4;

FIG. 7 is side view of a portion of the system shown in FIG. 4;

FIG. 8 is an axial view of the system shown in FIG. 4 being used to modify the rotor of the exemplary compressor shown in FIG. 1;

FIG. 9 is a perspective view of the system shown in FIG. 4 mounted on a rotor; and

FIG. 10 is a perspective view of the system shown in FIG. 4 modifying a rotor.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide an improved system and method for modifying a rotor. In particular embodiments, a drill may be mounted on the rotor in the radial space previously occupied by a removed blade, allowing the modification to be performed without requiring complete removal of a casing or any walls or other structures surrounding the rotor. Alternately or in addition, the system may include means for moving, axially aligning, measuring movement, and/or limiting movement of the drill so that the modification may be precisely and repeatably performed in the confined space. Although various embodiments of the present invention will be described in the context of a rotor included in a compressor, one of ordinary skill in the art will readily appreciate that the teachings of the present invention are not limited to a compressor rotor and may be equally applied to a rotor in other forms of rotating equipment.

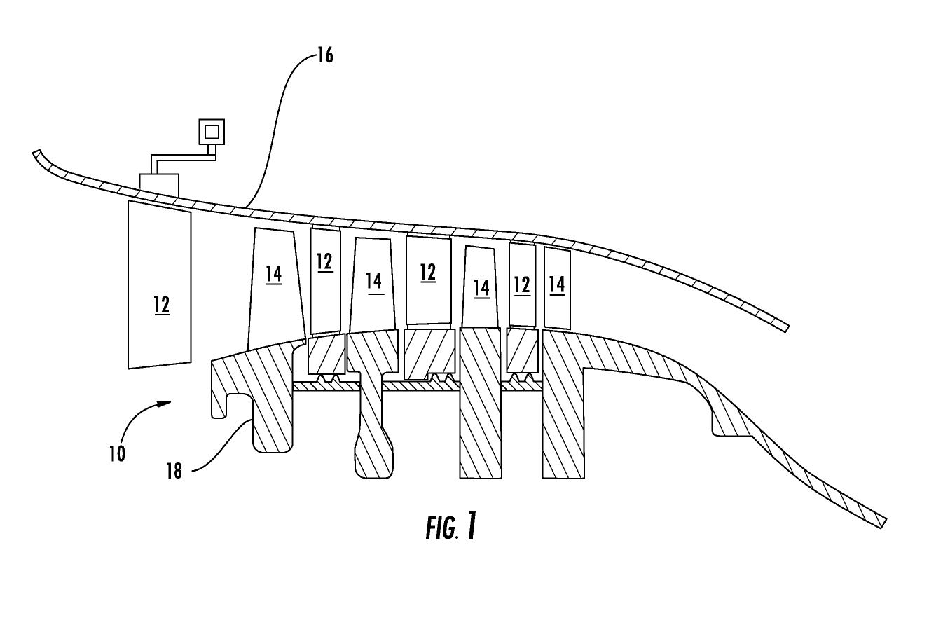

FIG. 1 provides a cross sectional view of an exemplary compressor 10 to illustrate various embodiments of the present invention. The compressor 10 generally includes alternating stages of stator vanes 12 and rotating blades 14 as is known in the art. The first stage of stator vanes 12 is commonly referred to as the inlet guide vane and may be adjustable to vary the amount or volume of air flow through the compressor 10. Each stage of stator vanes 12 and rotating blades 14 generally comprises a plurality of circumferentially arranged airfoils, with the stator vanes 12 attached to a casing 16 surrounding the compressor 10 and the rotating blades 14 attached to a rotor 18 generally aligned with an axial centerline of the compressor 10. In this manner, the stator vanes 12 direct the airflow entering the compressor 10 onto the following stage of rotating blades 14 to progressively impart kinetic energy to the working fluid (air) to bring it to a highly energized state.

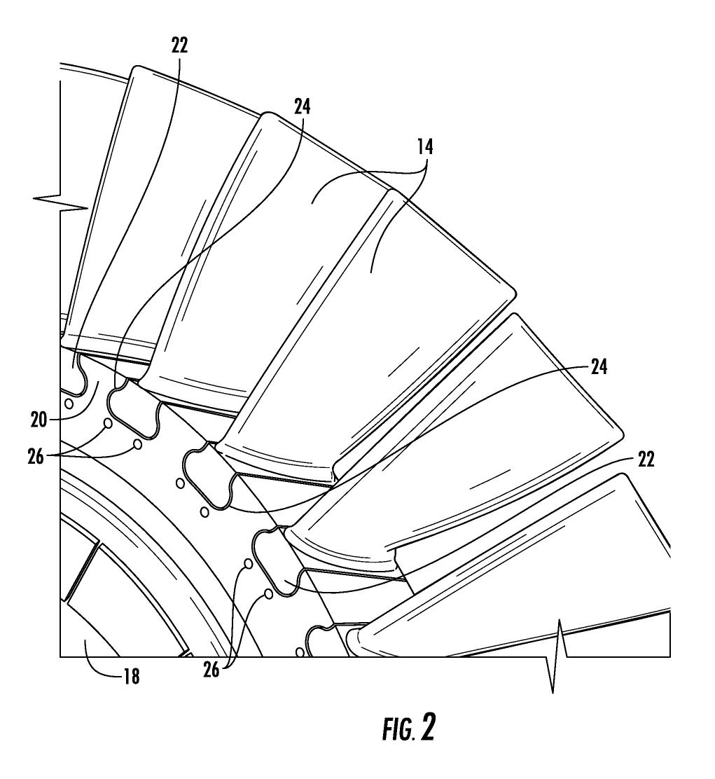

FIG. 2 provides an enlarged perspective view of a portion of a first stage of rotating blades 14 in the compressor 10. As shown, the rotating blades 14 extend radially from a rim 20 of the rotor 18. Each blade 14 generally includes a root 22 that slides into a slot 24 in the rim 20, and the complementary surfaces between the root 22 and the slot 24 prevent each blade 14 from moving radially. In addition, the rim 20 of the rotor 18 may be “staked” or plastically deformed, producing the characteristic stake marks 26 shown in FIG. 2, to prevent the root 22 from moving axially in the slot 24.

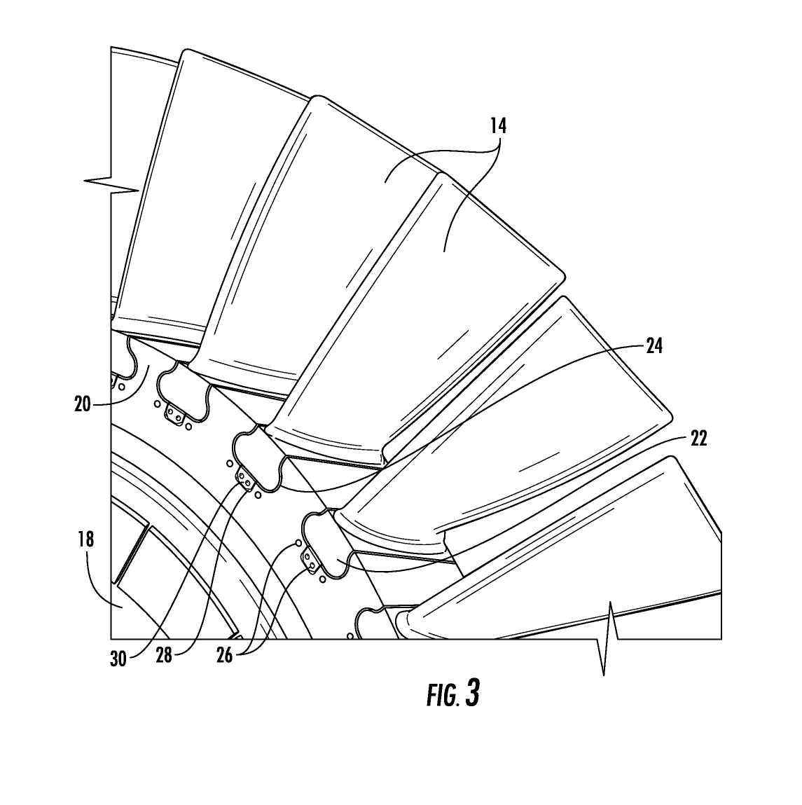

FIG. 3 provides an enlarged perspective view of the first stage of rotating blades 14 shown in FIG. 2 after being modified with an embodiment of the present invention. As shown, a portion of the rim 20 has been machined to form a cavity 28 in the slot 24. An insert 30 or biscuit has been placed in the cavity 28 and staked to axially restrain the root 22 in the slot 24. In this manner, each rotating blade 14 may be repeatedly removed from the rotor 18, and a new insert 30 may be placed in the cavity 28 to stake the rotating blade 14 in place once reinstalled.

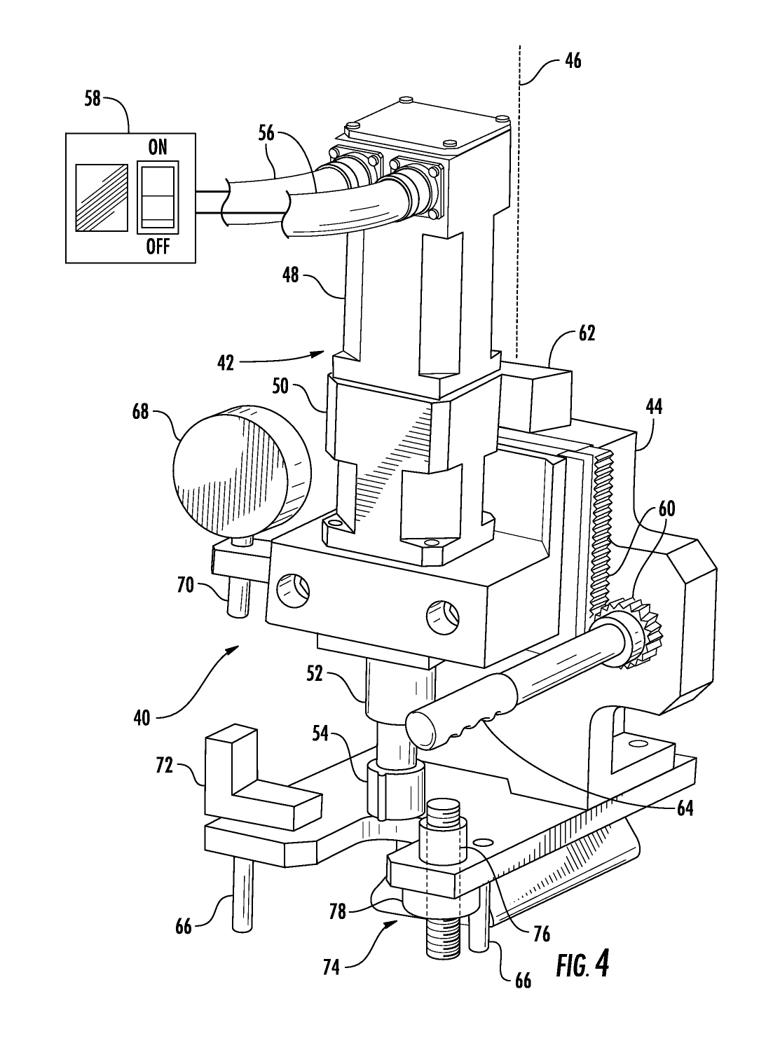

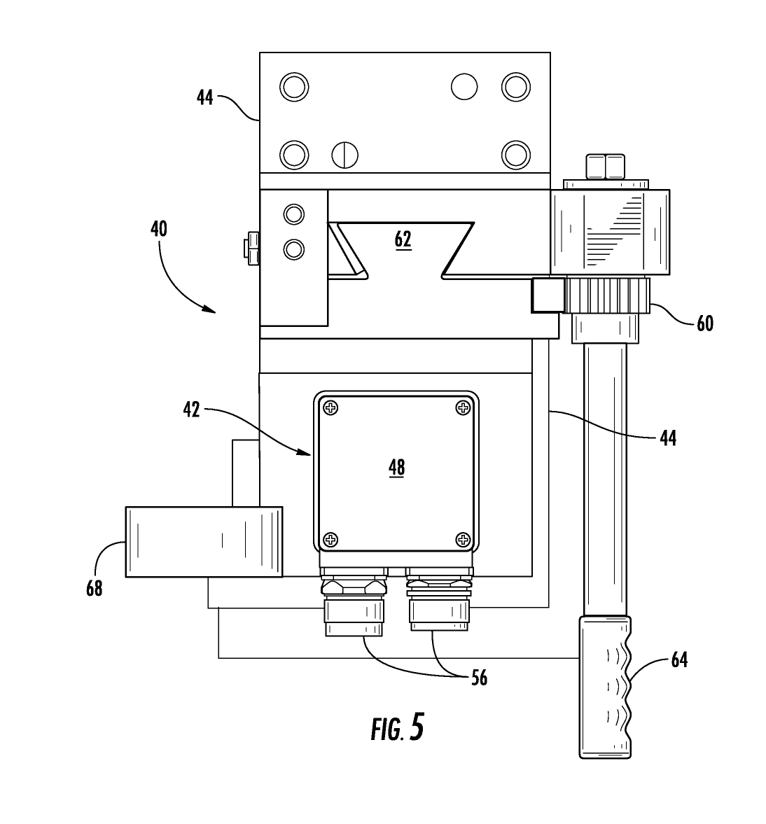

FIGS. 4-7 provide perspective, top, front, and side views, respectively, of a system 40 for modifying the rotor 18 according to an embodiment of the present invention. As shown, the system 40 generally comprises a drill 42 slidingly connected to a base 44 along a vertical axis 46. The drill 42 may comprise, for example, a pneumatic, hydraulic, or electric motor 48 connected by a gearbox 50 to a drill chuck 52 configured to retain a drill bit 54, as is known in the art. Cables 56 connected to the motor 48 may supply pneumatic, hydraulic, or electric power to operate the motor 48, and a controller 58 may allow an operator to remotely actuate the motor 48 as desired. One or more gears may provide a geared connection 60 between the drill 42 and the base 44 to provide a mechanical advantage for sliding the drill 42 along a rail 62 aligned with or parallel to the vertical axis 46. The number and orientation of gears and particular gear ratio achieved by the geared connection 60 may be easily determined by one of ordinary skill in the art without undue experimentation and is not a limitation of the present invention unless specifically recited in the claims. For example, as shown in FIGS. 4-6, a handle 64 may be operably connected to the geared connection 60 so that rotation of the handle 64 causes the geared connection 60 to advance or retract the drill 42 along the rail 62, thus repositioning the drill 42 vertically with respect to the base 44. Once positioned at a desired location, actuation of the motor 48 will drive the drill bit 54 to machine or bore the cavity 28 in the rotor 18, and the handle may be further rotated to advance or retract the drill bit 54 in the cavity 28.

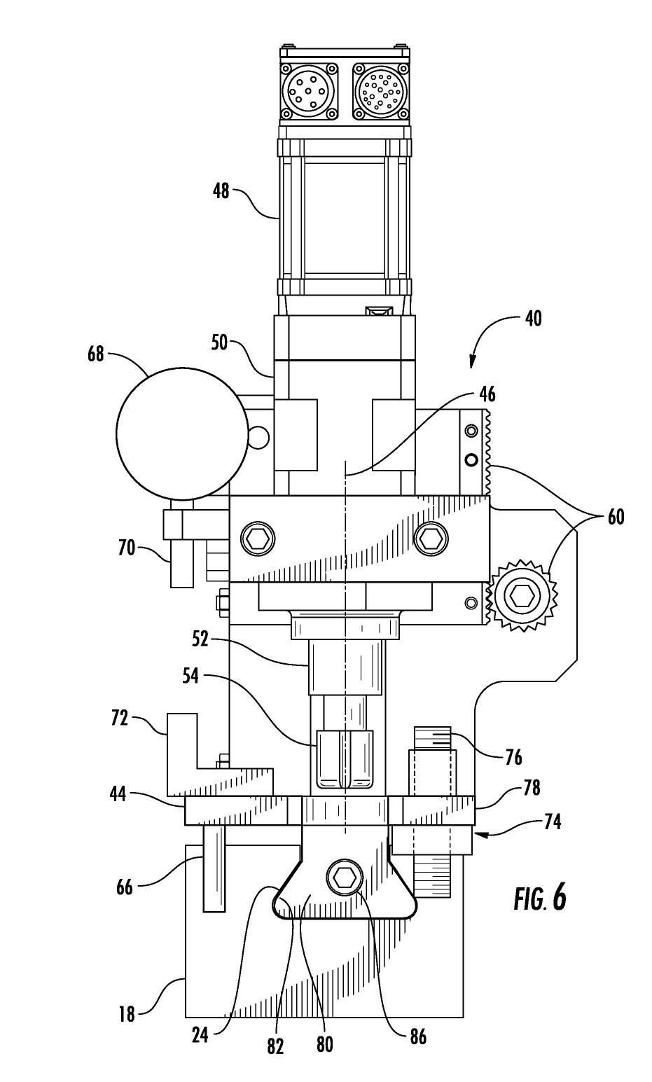

As can be seen in FIG. 3, the location and depth of the cavity 28 in the slot 24 is specifically selected to allow the insert 30 to fit in the cavity 28 without extending excessively beyond the front surface of the rotor 18. As a result, the system 40 may further include one or more components or devices that precisely position the drill 42 and/or base 44 with respect to the slot 24, that precisely measure movement of the drill 42 along the vertical axis 46, and/or that limit radial movement of the drill 42 along the vertical axis 46. For example, as shown most clearly in FIGS. 4 and 6, the system 40 may include means for axially aligning the drill 42 and/or the base 44 with respect to the slot 24. The means for axially aligning the drill 42 and/or the base 44 with respect to the slot 24 may comprise, for example, one or more projections or alignment tabs 66 that extend radially from the drill 42 and/or base 44. In this manner, the one or more projections may contact with the front face of the rotor 18 to axially align the drill 42 and/or base 44 with respect to the slot 24. Other suitable structures for performing the function of axially aligning the drill 42 and/or base 44 with respect to the slot 24 may comprise one or more detents, measurement strips, straight edges, pins, or similar devices attached to the drill 42 and/or base 44.

Alternately or in addition, the system 40 may include means for measuring movement of the drill 42 along the vertical axis 46. The means for measuring movement of the drill 42 along the vertical axis 46 may comprise any sensor that measures radial movement of the drill 42 along the vertical axis 46. For example, as shown in FIGS. 4-6, the means for measuring movement of the drill 42 along the vertical axis 46 may comprise a micrometer 68 connected to the drill 42 so that the micrometer 68 moves radially with the drill 42 as the drill 42 slides along the vertical axis 46. The micrometer 68 may include a retractable plunger 70 configured to contact a reference plate 72 so that the micrometer 68 may measure movement of the retractable plunger 70 as the drill 42 moves along the vertical axis 46. In alternate embodiments, the micrometer 68 or other sensor may be connected to the base 44 or other stationary component with respect to the drill 42 to measure radial movement of the drill 42 along the vertical axis 46.

In still further embodiments, the system 40 may include means for limiting movement of the drill 42 along the vertical axis 46. For example, as shown most clearly in FIGS. 4 and 6, a mechanical stop 74 between the drill 42 and the base 44 physically limits vertical movement of the drill 42 with respect to the base 44 and thus along the vertical axis 46. The mechanical stop 74 may comprise, for example, a stud 76 in threaded engagement with the base 44 so that the height of the stud 76 relative to the base 44 may be adjusted. The mechanical stop 74 may further include a lock 78, such as a bolt, nut, or ring, configured to engage the stud 76 and prevent the stud 76 from inadvertent movement. Additional suitable structures for limiting movement of the drill 42 along the vertical axis 46 may include, for example a detent, notch, or other mechanical device located on the geared connection 60 and/or rail 62 that limits radial movement of the drill 42 along the vertical axis 46.

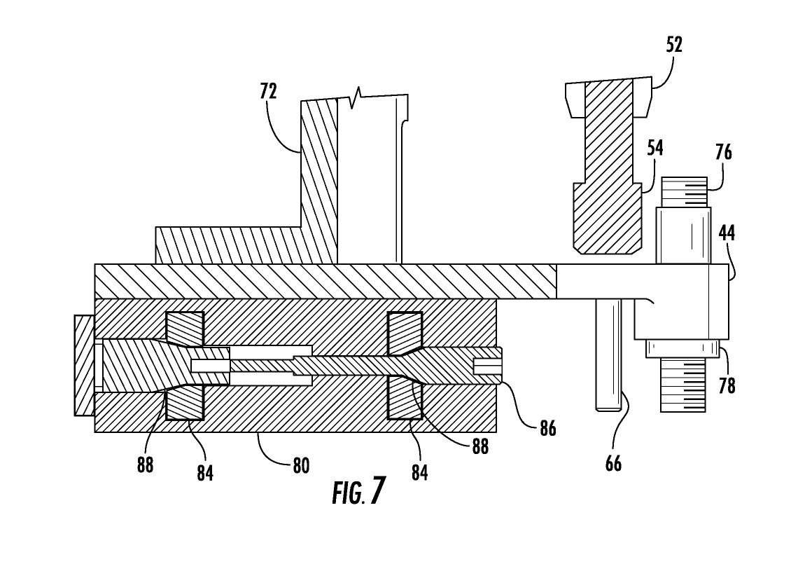

As shown most clearly in FIGS. 6 and 7, the system 40 may further include means for aligning the drill 42, base 44, and/or vertical axis 46 above or radially outward from the slot 24. In the particular embodiment shown in FIGS. 6 and 7, the means for aligning the drill 42, base 44, and/or vertical axis 46 above the slot 24 comprises a clamp 80 slidingly connected to the drill 42 and/or base 44 and that fits inside the slot 24. An outer perimeter 82 of the clamp 80 may approximately conform to the interior surface of the slot 24 so that when the clamp 80 is axially slid into the slot 24, at least a portion of the clamp 80 engages with the interior surface of the slot 24 to hold the drill 42, base 44, and/or vertical axis 46 above the slot 24. The clamp 80 may additionally include, for example, one or more projections 84 in threaded engagement with a set screw 86. Rotation of the set screw 86 may force the one or more projections 84 against an inclined surface 88 inside the clamp 80 to extend the projections 84 beyond the outer perimeter 82 of the clamp 80 to further bind the clamp 80 to the slot 24, thus preventing the system 40 from inadvertently moving while the drill 42 is operating. Additional suitable structures for aligning the drill 42, base 44, and/or vertical axis 46 above the slot 24 may include, for example, a vice, spanner, jack, or other equivalent mechanical device connected to at least one of the drill 42 or base 44 that may fixedly connect the system 40 to the slot 24.

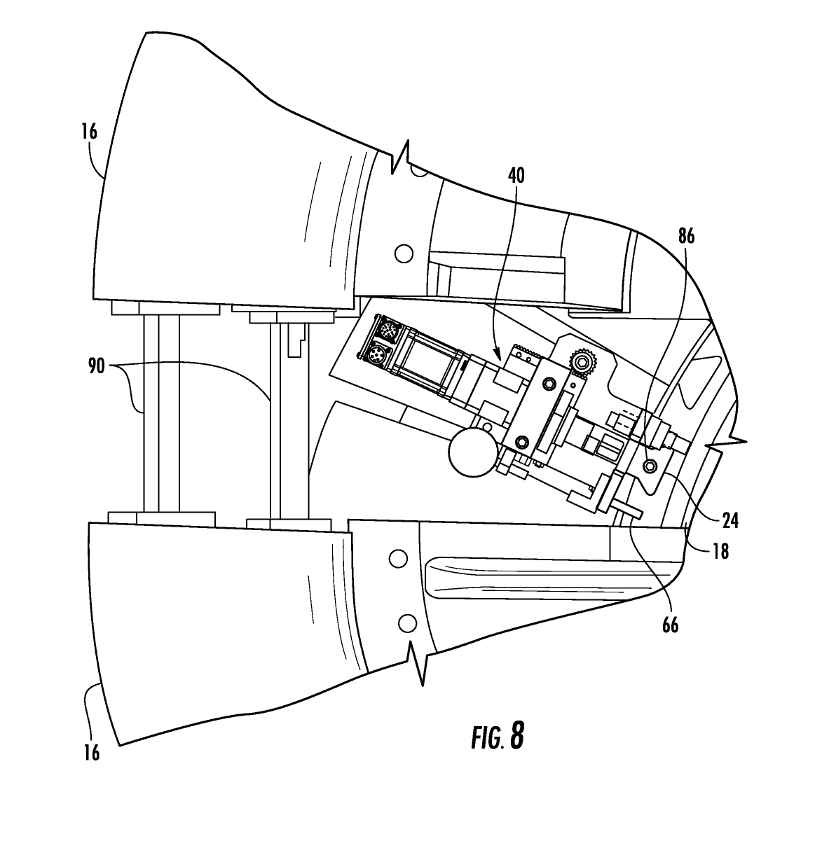

FIGS. 8-10 illustrate the system 40 shown in FIGS. 4-7 being used to modify the rotor 18 of the exemplary compressor 10 shown in FIG. 1. As shown in FIG. 8, the casing 16 has been unbolted, and stationary jacks 90 have been installed between the sections of the casing 16 to create an opening in the casing 16 of approximately 18-24 inches. This opening is large enough to allow insertion of the system 40 through the opening without requiring complete removal of the casing 16 or adjacent structures. The rotating blades 14 in the first stage have been removed, and the system 40 has been located above or proximate to the slot 24 being modified. The clamp 80 is aligned with the slot 24 being modified, and the system 40 is slid axially rearward, causing the clamp 80 to slide rearward inside the slot 24 until the alignment tabs 66 abut the front surface of the rotor 18. Once the alignment tabs 66 abut the front surface of the rotor 18, the drill 42 is axially aligned with the slot 24 to machine the cavity 28 in the desired position, and the outer surface 82 of the clamp 80 engages with the interior surface of the slot 24 to hold the system 40 in place. The set screw 86, if present, may be rotated to further tighten the clamp 80 inside the slot 24. For example, as previously discussed with respect to FIG. 7, rotation of the set screw 86 may force the projections 84 against the inclined surface 88 inside the clamp 80 to extend the projections 84 beyond the outer perimeter 82 of the clamp 80 to further bind the clamp 80 to the slot 24.

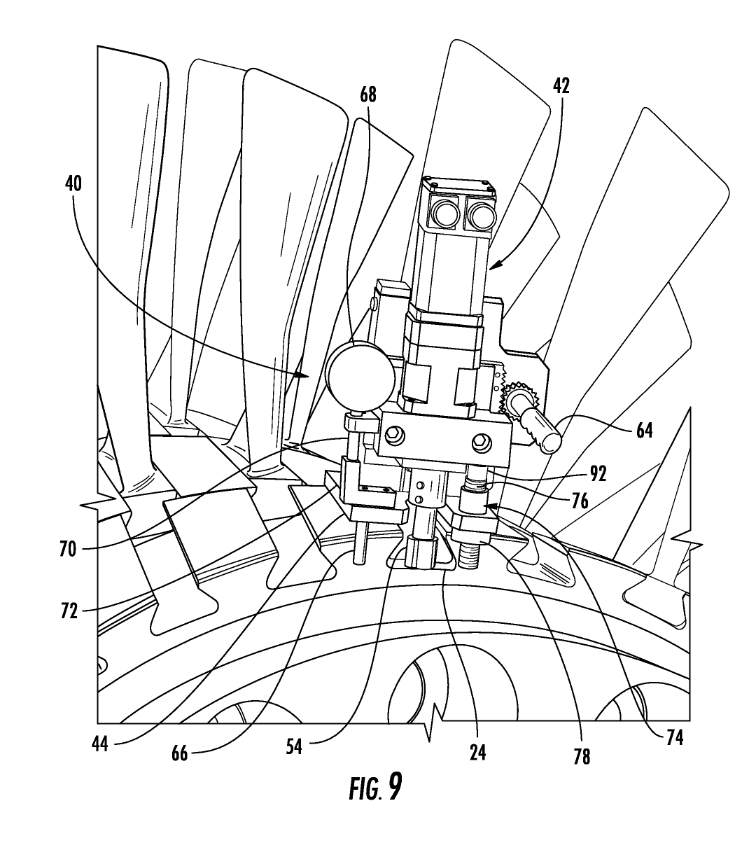

As shown in FIG. 9, the handle 64 has been rotated to move the drill 42 radially inward along the vertical axis 46 until the drill bit 54 contacts the inner surface of the slot 24 at the desired location of the cavity 28. A precision block 92 having the same thickness as the insert 30 may be placed on top of the mechanical stop 74, and the stud 76 may be rotated until the precision block 92 abuts the drill 42. The precision block 92 may then be removed from the mechanical stop 74, and the lock 78 may be applied to the stud 76 so that the resulting distance between the drill 42 and the top of the stud 76 equals the desired depth of the cavity 28 to be machined into the slot 24. With the drill bit 54 in contact with the inner surface of the slot 24, the micrometer 68 may be zeroed to allow accurate measurement of the radial movement of the drill 42 along the vertical axis 46.

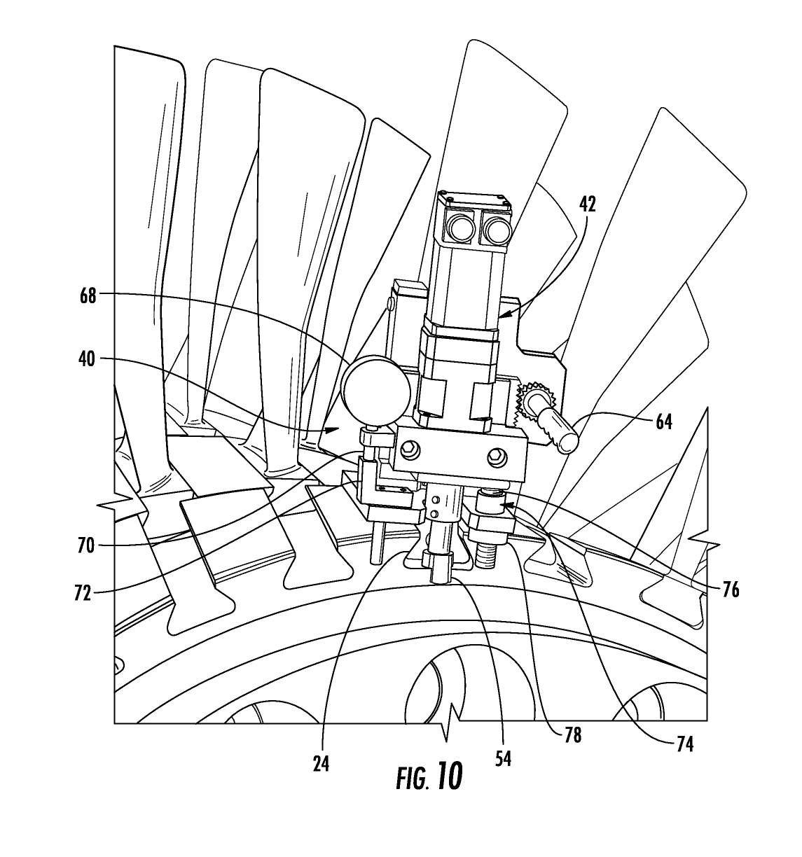

In FIG. 10, the drill 42 has been actuated, and the handle 64 has been rotated to advance the drill 42 radially inward along the vertical axis 46. As a result, the drill bit 54 machines the cavity 28 into the bottom of the slot 24. The micrometer 68 provides a continuous indication of the depth of the drill bit 54 in the slot 24, and the mechanical stop 74 ensures that the desired depth of the cavity 28 is not exceeded. When the desired depth of the cavity 28 is reached, as indicated by the micrometer 68 or contact with the mechanical stop 74, the handle 64 may be rotated in the opposite direction to withdraw the drill 42 radially outward along the vertical axis 46. The set screw 86, if present, may then be rotated to loosen the clamp 80 inside the slot 24. The system 40 may then be slid axially forward until the clamp 80 clears the slot 24, and the system 40 may be located proximate to or above the next slot 24 to be machined.

The system 40 described and illustrated with respect to FIGS. 4-10 provides one or more benefits over the existing technology used to modify rotors. For example, the system 40 contemplated within the scope of the present invention is considerably smaller and lighter than the existing technology. Specifically, the drill 42 and clamp 80 are designed to be located or aligned with the same slot 24, allowing the system 40 to fit within the width created by the removal of a single rotating blade 14. In addition, the lighter weight of the system 40 allows the system 40 to be more easily manipulated within the tight confines around the rotor 18. As a result, the system 40 does not require the complete removal of the casing 16 and/or adjacent structures, installation of scaffolding, or the use of an external crane to move the system 40 between slots 24, all of which result in substantial savings in preparing the rotor 18 for modification and restoring the rotor 18 to service upon completion of the modification.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for modifying a slot in a rotor, comprising:
a. a base, wherein said base includes a vertical axis;
b. a drill slidingly connected to said base along said vertical axis; and
c. a clamp connected to said base and configured to engage with an interior surface of the slot.

2. The system as in claim 1, wherein at least a portion of said clamp has a shape that approximately conforms to the interior surface of the slot.

3. The system as in claim 1, wherein said clamp comprises a projection, wherein said projection binds said clamp to the slot when said projection is extended from said clamp.

4. The system as in claim 1, wherein said drill comprises at least one of a pneumatic, hydraulic, or electric motor.

5. The system as in claim 1, further comprising a geared connection between said drill and said base.

6. The system as in claim 1, further comprising means for axially aligning said drill with respect to the slot.

7. The system as in claim 1, further comprising means for measuring movement of said drill along said vertical axis.

8. The system as in claim 1, further comprising means for limiting movement of said drill along said vertical axis.

9. A system for modifying a slot in a rotor, comprising:
a. a base, wherein said base includes a vertical axis;
b. a drill slidingly connected to said base along said vertical axis; and
c. means for aligning said drill above the slot.

10. The system as in claim 9, wherein said means for aligning said drill above the slot comprises a shape that approximately conforms to an interior surface of the slot.

11. The system as in claim 9, wherein said means for aligning said drill above the slot comprises a set screw.

12. The system as in claim 9, wherein said drill comprises at least one of a pneumatic, hydraulic, or electric motor.

13. The system as in claim 9, further comprising a geared connection between said drill and said base.

14. The system as in claim 9, further comprising means for axially aligning said drill with respect to the slot.

15. The system as in claim 9, further comprising means for measuring movement of said drill along said vertical axis.

16. The system as in claim 9, further comprising means for limiting movement of said drill along said vertical axis.

17. A method for modifying a slot in a rotor, comprising:
a. locating a drill proximate to the slot;
b. inserting a clamp into the slot, wherein said clamp is slidingly connected to said drill;
c. engaging said clamp with an interior surface of the slot; and
d. operating said drill to create a cavity in the slot.

18. The method as in claim 17, further comprising axially aligning said drill with respect to the slot.

19. The method as in claim 17, further comprising measuring movement of said drill along said vertical axis.

20. The method as in claim 17, further comprising limiting movement of said drill along said vertical axis.
